(19) United States
(12) Patent Application Publication
(10) Pub. No.: US 2020/0098339 A1
(43) Pub. Date: Mar. 26, 2020

(54) PANNING DISPLAYED INFORMATION TO COMPENSATE FOR PARKINSON'S DISEASE INDUCED MOTION OF ELECTRONIC DEVICES

(71) Applicant: CA, Inc., New York, NY (US)

(72) Inventors: Vikrant Nandakumar, Bangalore (IN); Lyju Vadassery, Mumbai (IN); Vijay Shashikant Kulkarni, Bangalore (IN); Madhusudhan Ganda, Kadapa (IN)

(73) Assignee: CA, Inc., New York, NY (US)

(21) Appl. No.: 16/136,427

(22) Filed: Sep. 20, 2018

(51) Int. Cl. G09G 5/34; G06T 7/20

(52) U.S. Cl. CPC G09G 5/34; G06T 7/20; G09G 2380/08; G09G 2354/00; G06T 2207/10016; G09G 2340/0464

(57) ABSTRACT

A method of performing operations on a processor of an electronic device includes obtaining motion data from a sensor that characterizes motion of the electronic device. The operations filter the motion data to identify a component of the motion caused by Parkinson's disease. The operations determine direction and distance for panning displayed information to at least partially compensate for the identified component of the motion. The operations tracking in real-time a phase of sensed motion. The operations control panning of information that is displayed on a display device responsive to the determined direction and distance and responsive to the phase of the sensed motion.

### BACKGROUND

The present disclosure relates to electronic devices and, more particularly, to user interfaces for portable electronic devices.

Parkinson disease (PD) is a common disorder that affects the brain's ability to control movement. More than 1 million people in North America alone have been diagnosed with PD, most of whom are greater than 60 years old. Parkinson disease progressively worsens over time, although the rate of worsening varies greatly from one person to another. One result of the brain's inability to control movement is that the person's hands can shake uncontrollably which can render the hands relatively useless for certain purposes, such as for holding an electronic device while reading text or other displayed information.

### SUMMARY

Some embodiments of the present disclosure are directed to a method of performing operations on a processor of an electronic device. The operations include obtaining motion data from a sensor that characterizes motion of the electronic device. The operations filter the motion data to identify a component of the motion caused by Parkinson's disease. The operations determine direction and distance for panning displayed information to at least partially compensate for the identified component of the motion. The operations tracking in real-time a phase of the sensed motion. The operations control panning of information that is displayed on a display device responsive to the determined direction and distance and responsive to the phase of the sensed motion.

The operations may thereby pan the displayed information in a way that improves viewability by a user who is physically shaking the electronic device being held in the user's hand due to the effect of Parkinson's disease on the user's neuro-muscular control of the hand.

Corresponding operations by computer program products and electronic devices are disclosed. Other methods, computer program products, and electronic devices according to embodiments will be or become apparent to one with skill in the art upon review of the following drawings and detailed description. It is intended that all such additional methods, computer program products, and electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates an electronic device that controls panning of information displayed on a display device to at least partially compensate for motion of the electronic device caused by the effects of Parkinson's disease on the user, according to some embodiments of the present disclosure;

FIG. 2 illustrates components of a compensation control circuit within the electronic device of FIG. 1 and which are configured according to some embodiments of the present disclosure;

FIG. 3 illustrates a graph of an example motion component that is identified by the Parkinson's disease based motion characterization module of FIG. 2 by filtering the sensed motion of the electronic device according to some embodiments of the present disclosure;

FIG. 4 illustrates a graph of an example panning motion that is output by the motion compensation module of FIG. 2 according to some embodiments of the present disclosure;

FIG. 5 illustrates a flowchart of operations that may be performed by an electronic device to control panning of displayed information in accordance with some embodiments of the present disclosure;

FIG. 6 illustrates a flowchart of operations that may be performed by an electronic device to determine direction and distance for panning displayed information in accordance with some embodiments of the present disclosure; and

FIG. 7 is a block diagram of an electronic device configured according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As explained above, person suffering from Parkinson's disease typically have uncontrolled hand movements. A consequence is that those persons can have tremendous difficulty when attempting to read information displayed on a display device of electronic device. Various embodiments of the present disclosure are directed to operations and methods that can at least partially compensate for such movements to improve the readability of information is displayed by electronic device.

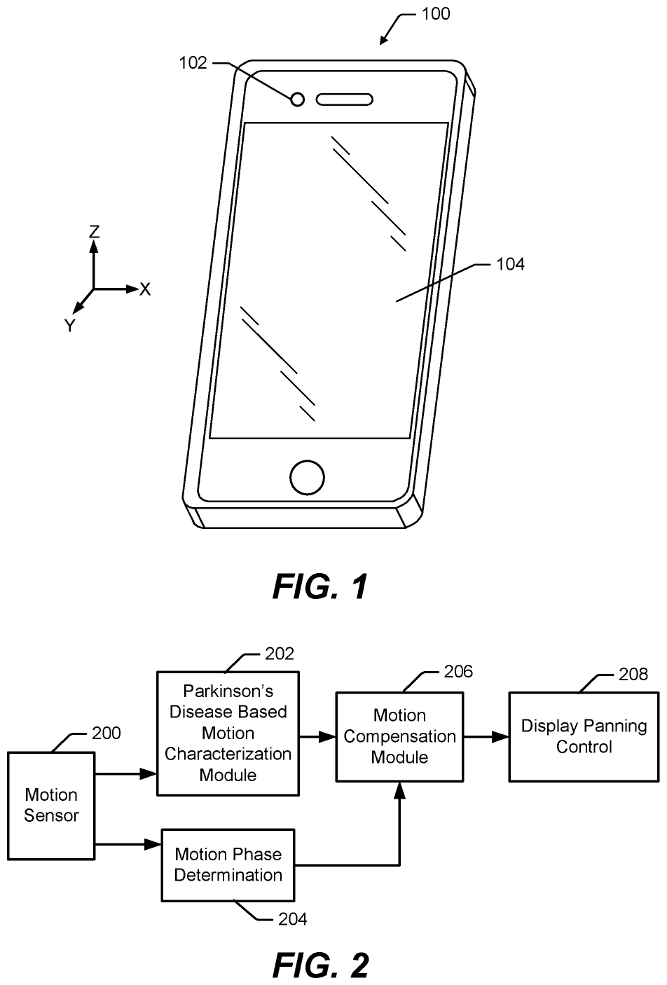

FIG. 1 illustrates an electronic device 100 that controls panning of information displayed on a display device 104 to at least partially compensate for motion of the electronic device caused by the effects of Parkinson's disease on the user, according to some embodiments of the present disclosure. Referring to FIG. 1, the electronic device 100 includes a display device 104 and a motion sensor which may include a forward-facing camera 102, a rear facing camera, accelerometers, etc. The electronic device 100 can include, but is not limited to, a smartphone, a tablet computer, a media player, an electronic reader, a personal computer, a gaming console, and/or another type of user operable device.

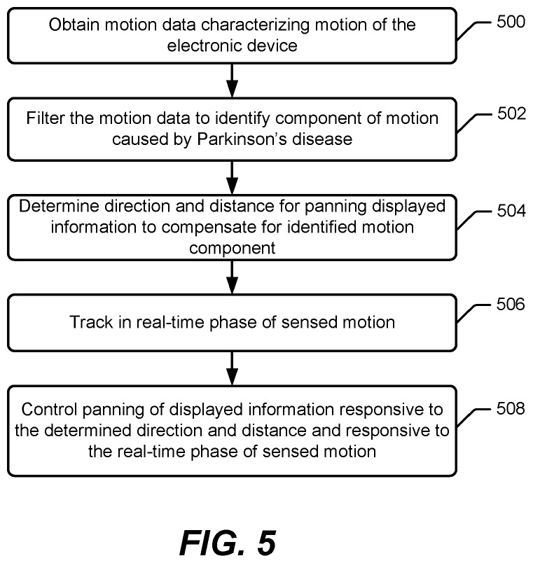

FIG. 5 illustrates a flowchart of operations that may be performed by the electronic device 100 to control panning of displayed information in accordance with some embodiments of the present disclosure. Referring to FIG. 5, the electronic device 100 includes a processor that performs operations to obtain 500 motion data from a sensor that characterizes motion of the electronic device. The motion sensor may be the forward-facing camera 102, a rear-facing camera, accelerometers, etc. A camera can be used to sense motion by, for example, tracking movement of an object within the field of view of the camera, and determining the distance that the object moves, the periodicity of the movement, the phase of the movement along the repeating path of object movement, the amplitude of the object movement, etc. The operations filter 502 the motion data to identify a component of the motion caused by Parkinson's disease. The filtering may include identifying motion that has a periodicity that is within a typical range of hand tremors/shaking that is experienced by persons suffering from Parkinson's disease or that is determined as being a typical periodicity of hand shaking for the particular user of the electronic device as observed by a processor of the device 100 over a defined period of time.

The operations determine 504 direction and distance for panning information (e.g., text, graphical objects, etc.) that is displayed on the display device 104 information to at least partially compensate for the identified component of the motion. The operations track 506 in real-time a phase of sensed motion, e.g., via the cell around her and/or camera. The operations then control 508 panning of information that is displayed on the display device 104 responsive to the determined direction and distance and responsive to the phase of the sensed motion.

In one embodiment, the operations may zoom-in to enlarge a sub-window of information displayed on the display device 104, and then control panning of that sub-window that is displayed on the display device 104 responsive to the determined direction and distance and responsive to the phase of the sensed motion.

FIG. 2 illustrates components of a compensation control circuit within the electronic device 100 of FIG. 1 and which are configured according to some embodiments of the present disclosure. The components include a motion sensor 200 (e.g., camera 102 and/or accelerometer), a Parkinson's disease based motion characterization module 202, a motion phase determination module 204, a motion compensation module 206, and a display panning control module 208. The motion characterization module 202 obtains the motion data from the motion sensor 200 that characterizes motion of the electronic device 100, and filters the motion data to identify a component of the motion caused by Parkinson's disease, and determines direction and distance for panning displayed information to at least partially compensate for the identified component of the motion. The motion phase determination module 204 tracks in real-time a phase of the sensed motion. The motion compensation module 206 controls panning of information that is displayed on the display device 104 responsive to the determined direction and distance and responsive to the phase of the sensed motion. The display panning control module 208 controls where information is displayed on the display device 104 responsive to the control output of the motion compensation module 206. Panning of the displayed information is controlled based on the presently sensed phase of motion so that the information can be moved in and opposite direction to that motion, and which may be moved with a velocity that changes based on where the phase is along the repetitive motion occurring with the electronic device 100 (e.g., speed of panning can be increased as the speed of the device motion increases during the repetitive motion).

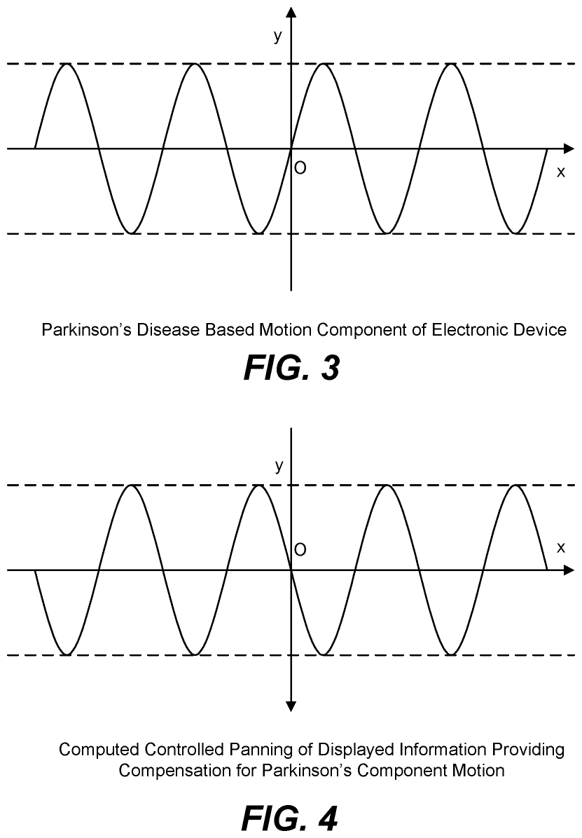

FIG. 3 illustrates a graph of an example motion component that is identified by the Parkinson's disease based motion characterization module 202 of FIG. 2 by filtering the sensed motion of the electronic device 100 according to some embodiments of the present disclosure. The graph is a simplified example of a periodic sinusoidal waveform that can be isolated by the module 206 as a component of the sensed motion of the electronic device 100 and which characterizes the amplitude and periodicity of the motion that is caused by Parkinson's disease.

FIG. 4 illustrates a graph of an example panning motion that is output by the motion compensation module 206 of FIG. 2 according to some embodiments of the present disclosure. The illustrated panning motion has an amplitude that is determined based on the amplitude of the motion component of FIG. 3, and which has been phase-aligned to be 180 degrees out of phase with the motion component of FIG. 3 in order to at least partially compensate for the identified motion component due to Parkinson's disease. Accordingly, as the electronic device 100 is moved in a first direction by the person's hand, the motion compensation module 206 controls the display panning control module 208 to pan the displayed information in a second direction that is opposite to the first direction in order to reduce perceived movement of the displayed information when viewed by the person.

In one embodiment, the operation to obtain motion data from a sensor 200 that characterizes motion of the electronic device, can include obtaining acceleration data from an accelerometer of the electronic device 100 that characterizes acceleration of the electronic device 100 along at least one axis. The operation to filter the motion data to identify a component of the motion caused by Parkinson's disease, includes determining a fundamental amplitude and period of the acceleration that is within a define range that is characteristic of motion caused by Parkinson's disease and which characterizes a primary mode of motion associated with the acceleration.

In another embodiment, the operation to obtain motion data from a sensor 200 that characterizes motion of the electronic device 100, includes obtaining video data from a camera 102 of the electronic device 100, and identifying a pattern of motion of an object within the video data. The operation to filter the motion data to identify a component of the motion caused by Parkinson's disease, includes determining a fundamental amplitude and period of the pattern of motion of the object within the video data that is within a define range that is characteristic of motion caused by Parkinson's disease.

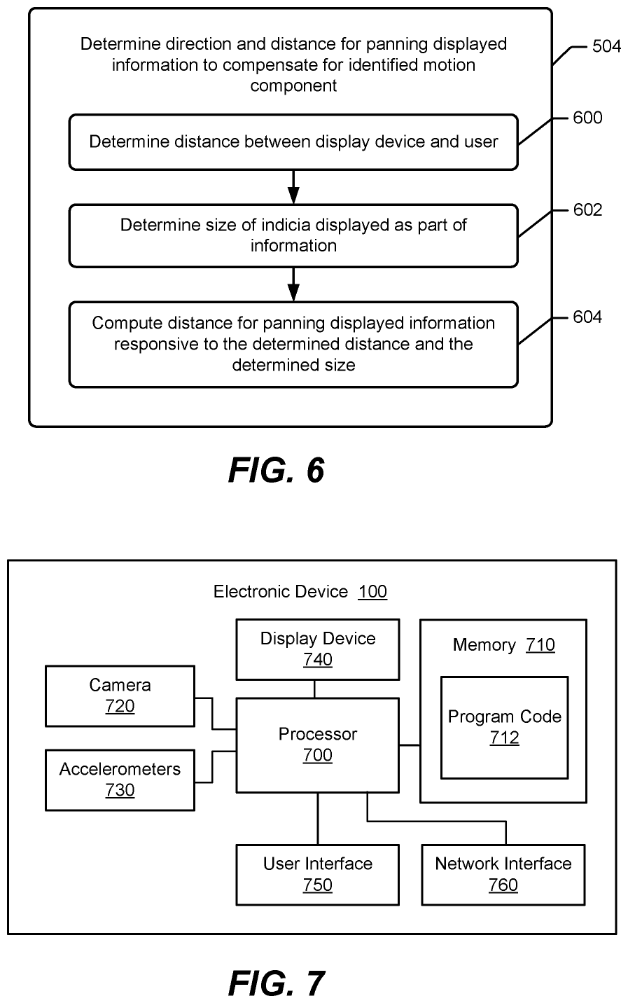

FIG. 6 illustrates a flowchart of operations that may be performed by an electronic device 100 to determine direction and distance for panning displayed information in accordance with some embodiments of the present disclosure.

In one embodiment, the operation to determine 504 direction and distance for panning displayed information to at least partially compensate for the identified component of the motion, includes determining 602 size of an indicia displayed as part of the information. Magnitude of the component of the motion along at least two axes is determined, and the direction and distance for panning displayed information are determined 604 responsive to the size of the indicia and to the magnitude of the component of the motion along the at least two axes.

The operation to determine 604 the direction and distance for panning displayed information responsive to the size of the indicia and to the magnitude of the component of the motion along the at least two axes, can include controlling the distance for panning displayed information based on an inverse proportional relationship to the size of the indicia. The operation to control the distance for panning displayed information based on an inverse proportional relationship to the size of the indicia, can include decreasing the distance for panning displayed information based on the size of the indicia increasing between two instances in time, and, in contrast, increasing the distance for panning displayed information based on the size of the indicia decreasing between two instances in time.

In another embodiment, the operation to determine 504 direction and distance for panning displayed information to at least partially compensate for the identified component of the motion, includes determining 600 distance between the display device and a user who is holding the electronic device. Magnitude of the component of the motion along at least two axes is determined, and the direction and distance for panning displayed information are determined 604 responsive to the magnitude of the component of the motion along the at least two axes and to the distance that is determined between the display device and a user who is holding the electronic device.

The operation to determine 604 the direction and distance for panning displayed information responsive to the magnitude of the component of the motion along the at least two axes and to the distance that is determined between the display device and a user who is holding the electronic device, can include controlling the distance for panning displayed information based on a proportional relationship to the size of the distance that is determined between the display device and a user who is holding the electronic device.

The operation to control 604 the distance for panning displayed information based on the proportional relationship to the size of the distance that is determined between the display device and a user who is holding the electronic device, can include decreasing the distance for panning displayed information based on the determined distance decreasing between two instances in time, and, in contrast, increasing the distance for panning displayed information based on the determined distance increasing between two instances in time.

The operation to determine 504 direction and distance for panning displayed information to at least partially compensate for the identified component of the motion, can include determining 600 size of an indicia displayed as part of the information, determining 602 distance between the display device and a user who is holding the electronic device, and determining magnitude of the component of the motion along at least two axes. The operations then determine 604 the direction and distance for panning displayed information responsive to the size of the indicia, to the magnitude of the component of the motion along the at least two axes, and to the distance that is determined between the display device and a user who is holding the electronic device.

FIG. 7 is a block diagram of an electronic device 100 configured according to some embodiments of the present disclosure. Referring to FIG. 7, the electronic device 100 includes a camera 720 and/or accelerometers 730, a processor 700, a memory 710, a display device 740, the user interface 750, and a network interface 760. The processor 700 performs operations to process output of the camera 102 and/or the accelerometers 730 to obtain motion data that characterizes motion of the electronic device 100. The processor 700 may include one or more data processing circuits, such as a general purpose and/or special purpose processor (e.g., microprocessor and/or digital signal processor) that may be collocated within the electronic device 700 or distributed across one or more networks. The processor 700 is configured to execute computer program code 712 in the memory 710, described below as a non-transitory computer readable medium, to perform at least some of the operations described herein as being performed by an electronic device or any component thereof. The user interface 750 may be a touch input interface on the display device 100, a keyboard, etc. The network interface 730 may be a wired network interface transceiver, e.g., Ethernet, and/or a wireless radiofrequency transceiver that is configured to operate according to one or more communication protocols, e.g., WiFi, Bluetooth, cellular LTE, etc.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on a processor of an electronic device:
obtaining motion data from a sensor that characterizes motion of the electronic device;
filtering the motion data to identify a component of the motion caused by Parkinson's disease;
determining direction and distance for panning displayed information to at least partially compensate for the identified component of the motion;
tracking in real-time a phase of sensed motion;
controlling panning of information that is displayed on a display device responsive to the determined direction and distance and responsive to the phase of the sensed motion.

2. The method of claim 1,
wherein the operation to obtain motion data from a sensor that characterizes motion of the electronic device, comprises:
obtaining acceleration data from an accelerometer of the electronic device that characterizes acceleration of the electronic device along at least one axis; and
wherein the operation to filter the motion data to identify a component of the motion caused by Parkinson's disease, comprises:
determining a fundamental amplitude and period of the acceleration that is within a define range that is characteristic of motion caused by Parkinson's disease and which characterizes a primary mode of motion associated with the acceleration.

3. The method of claim 1,
wherein the operation to obtain motion data from a sensor that characterizes motion of the electronic device, comprises:
obtaining video data from a camera of the electronic device; and
identifying a pattern of motion of an object within the video data; and
wherein the operation to filter the motion data to identify a component of the motion caused by Parkinson's disease, comprises:
determining a fundamental amplitude and period of the pattern of motion of the object within the video data that is within a define range that is characteristic of motion caused by Parkinson's disease.

4. The method of claim 1, wherein the operation to determine direction and distance for panning displayed information to at least partially compensate for the identified component of the motion, comprises:
determining size of an indicia displayed as part of the information;
determining magnitude of the component of the motion along at least two axes; and
determining the direction and distance for panning displayed information responsive to the size of the indicia and to the magnitude of the component of the motion along the at least two axes.

5. The method of claim 4, wherein the operation to determine the direction and distance for panning displayed information responsive to the size of the indicia and to the magnitude of the component of the motion along the at least two axes, comprises:
controlling the distance for panning displayed information based on an inverse proportional relationship to the size of the indicia.

6. The method of claim 5, wherein the operation to control the distance for panning displayed information based on an inverse proportional relationship to the size of the indicia, comprises:
decreasing the distance for panning displayed information based on the size of the indicia increasing between two instances in time; and
increasing the distance for panning displayed information based on the size of the indicia decreasing between two instances in time.

7. The method of claim 1, wherein the operation to determine direction and distance for panning displayed information to at least partially compensate for the identified component of the motion, comprises:
determining distance between the display device and a user who is holding the electronic device;
determining magnitude of the component of the motion along at least two axes; and
determining the direction and distance for panning displayed information responsive to the magnitude of the component of the motion along the at least two axes and to the distance that is determined between the display device and a user who is holding the electronic device.

8. The method of claim 7, wherein the operation to determine the direction and distance for panning displayed information responsive to the magnitude of the component of the motion along the at least two axes and to the distance that is determined between the display device and a user who is holding the electronic device, comprises:
controlling the distance for panning displayed information based on a proportional relationship to the size of the distance that is determined between the display device and a user who is holding the electronic device.

9. The method of claim 8, wherein the operation to control the distance for panning displayed information based on the proportional relationship to the size of the distance that is determined between the display device and a user who is holding the electronic device, comprises:
decreasing the distance for panning displayed information based on the determined distance decreasing between two instances in time; and
increasing the distance for panning displayed information based on the determined distance increasing between two instances in time.

10. The method of claim 1, wherein the operation to determine direction and distance for panning displayed information to at least partially compensate for the identified component of the motion, comprises:
determining size of an indicia displayed as part of the information;
determining distance between the display device and a user who is holding the electronic device;
determining magnitude of the component of the motion along at least two axes; and
determining the direction and distance for panning displayed information responsive to the size of the indicia, to the magnitude of the component of the motion along the at least two axes, and to the distance that is determined between the display device and a user who is holding the electronic device.

11. A computer program product comprising:
a non-transitory computer readable medium storing program code that is executed by a processor of an electronic device to perform operations comprising:
obtaining motion data from a sensor that characterizes motion of the electronic device;
filtering the motion data to identify a component of the motion caused by Parkinson's disease;
determining direction and distance for panning displayed information to at least partially compensate for the identified component of the motion;
tracking in real-time a phase of sensed motion;
controlling panning of information that is displayed on a display device responsive to the determined direction and distance and responsive to the phase of the sensed motion.

12. The computer program product of claim 11,
wherein the operation to obtain motion data from a sensor that characterizes motion of the electronic device, comprises:
obtaining acceleration data from an accelerometer of the electronic device that characterizes acceleration of the electronic device along at least one axis; and
wherein the operation to filter the motion data to identify a component of the motion caused by Parkinson's disease, comprises:
determining a fundamental amplitude and period of the acceleration that is within a define range that is characteristic of motion caused by Parkinson's disease and which characterizes a primary mode of motion associated with the acceleration.

13. The computer program product of claim 11,
wherein the operation to obtain motion data from a sensor that characterizes motion of the electronic device, comprises:
obtaining video data from a camera of the electronic device; and
identifying a pattern of motion of an object within the video data; and
wherein the operation to filter the motion data to identify a component of the motion caused by Parkinson's disease, comprises:
determining a fundamental amplitude and period of the pattern of motion of the object within the video data that is within a define range that is characteristic of motion caused by Parkinson's disease.

14. The computer program product of claim 11, wherein the operation to determine direction and distance for panning displayed information to at least partially compensate for the identified component of the motion, comprises:
determining size of an indicia displayed as part of the information;
determining magnitude of the component of the motion along at least two axes; and
determining the direction and distance for panning displayed information responsive to the size of the indicia and to the magnitude of the component of the motion along the at least two axes.

15. The computer program product of claim 14, wherein the operation to determine the direction and distance for panning displayed information responsive to the size of the indicia and to the magnitude of the component of the motion along the at least two axes, comprises:
controlling the distance for panning displayed information based on an inverse proportional relationship to the size of the indicia.

16. The computer program product of claim 15, wherein the operation to control the distance for panning displayed information based on an inverse proportional relationship to the size of the indicia, comprises:
decreasing the distance for panning displayed information based on the size of the indicia increasing between two instances in time; and
increasing the distance for panning displayed information based on the size of the indicia decreasing between two instances in time.

17. The computer program product of claim 11, wherein the operation to determine direction and distance for panning displayed information to at least partially compensate for the identified component of the motion, comprises:
determining distance between the display device and a user who is holding the electronic device;
determining magnitude of the component of the motion along at least two axes; and
determining the direction and distance for panning displayed information responsive to the magnitude of the component of the motion along the at least two axes and to the distance that is determined between the display device and a user who is holding the electronic device.

18. The computer program product of claim 17, wherein the operation to determine the direction and distance for panning displayed information responsive to the magnitude of the component of the motion along the at least two axes and to the distance that is determined between the display device and a user who is holding the electronic device, comprises:
controlling the distance for panning displayed information based on a proportional relationship to the size of the distance that is determined between the display device and a user who is holding the electronic device.

19. The computer program product of claim 18, wherein the operation to control the distance for panning displayed information based on the proportional relationship to the size of the distance that is determined between the display device and a user who is holding the electronic device, comprises:
decreasing the distance for panning displayed information based on the determined distance decreasing between two instances in time; and
increasing the distance for panning displayed information based on the determined distance increasing between two instances in time.

20. The computer program product of claim 11, wherein the operation to determine direction and distance for panning displayed information to at least partially compensate for the identified component of the motion, comprises:
determining size of an indicia displayed as part of the information;
determining distance between the display device and a user who is holding the electronic device;
determining magnitude of the component of the motion along at least two axes; and
determining the direction and distance for panning displayed information responsive to the size of the indicia, to the magnitude of the component of the motion along the at least two axes, and to the distance that is determined between the display device and a user who is holding the electronic device.
